(19) United States
(12) Patent Application Publication
(10) Pub. No.: US 2005/0038602 A1
(43) Pub. Date: Feb. 17, 2005

(54) Terrestrial environment observation satellites

(75) Inventor: Junzo Uchida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC TOSHIBA Space Systems, Ltd.

(21) Appl. No.: 10/895,932

(22) Filed: Jul. 22, 2004

(30) Foreign Application Priority Data
Jul. 23, 2003 (JP) 278331/2003

(51) Int. Cl. H04B 7/185

(52) U.S. Cl. 702/2; 356/2; 455/12.1

(57) ABSTRACT

A terrestrial environment observation satellite is provided, which can solve such environmental problems as earth temperature increase, ozone layer destruction and occurrence of abnormal weather occurring on the whole earth scale on the basis of data obtained from a sensor mounted on a satellite undergoing excursion around the earth. A satellite located on a position above the equator of the earth spinning about the earth axis, is set to an equator orbit directed in a direction opposite to the direction of the earth spin. Thus, a region a is produced on the earth, which permits scanning of a point a plurality of times. The whole region data of the earth is thus detected over a south/north direction angle by progressively integration processing intermittently obtained reflected light components from regions b, c, d, . . . of the earth surface one region to another.

### BACKGROUND OF THE INVENTION

This application claims benefit of Japanese Patent Application No. 2003-278331 filed on Jul. 23, 2003, the contents of which are incorporated by the reference.

The present invention relates to improvements in terrestrial environment observation satellites, which are artificial satellites with a sensor mounted thereon for detecting the environment status of the earth surface.

In the case of observing the environment of the earth surface with a sensor at a position far remote from the earth by causing circulation of an artificial satellite along equator orbit around the earth, in many cases the satellite is caused to undergo excursion along the equator orbit at a low height (of about several hundreds km).

The recurring orbits can be classified into those for observing particular regions and those as pseudo-recurring orbits permitting recurrent observation of the whole earth for a predetermined period of time. To obtain one excursion data by finishing the observation of the whole earth, however, the observation satellite requires a long time of days. For example, in the case of observation satellite MOS (MOMO) currently in duty service, the satellite requires 17 days because it returns to the initial orbit in a 17-day cycle.

An observation satellite which can reduce such a cycle is disclosed in Literature 1 (Japanese Patent Laid-open Showa 60-187872). This observation satellite permit obtaining data of a broad region of the earth surface in a cycle of at least one circulation per day by emitting it up to an orbit in a direction opposite to the direction of the earth spin such as to cause its excursion around the earth.

With this observation satellite, it is possible to obtain images of the earth shape and sea surface in such a manner that a laser beam emitted from the satellite toward the earth is received in a receiving station on the earth and appropriately processed in signal processing on the receiving station side.

Although the observation satellite shown in Literature 1 has an excellent feature that it can obtain data over a region on the earth surface in a cycle of at least one circulation per day, it obtains images of the earth shape and sea surface in such a manner that a laser beam emitted toward the earth is received in a receiving station on the earth. Therefore, limitations are imposed on the position of installation and number of receiving stations.

### SUMMARY OF THE INVENTION

It is thus desired the appearance of a terrestrial environment observation satellite, which can contribute to the solution of environment problems, which are raised in the whole earth scale such as earth temperature increase, ozone layer destruction and generation of abnormal weather, without limitations as in the above.

According to an aspect of the present invention, there is provided a terrestrial environment observation satellite with a sensor mounted for detecting light reflected from the earth while undergoing excursion around the earth, wherein: the satellite undergoes excursion along an orbit set to an equator orbit directed in a direction opposite to the direction of the earth spin, undergoes excursion to return to a terrestrial point a plurality of times a day, and executes a process of integrating intermittently obtained reflected light beam from the earth surface, thereby obtaining whole earth data.

The sensor is constituted by a bio-mass detecting means for detecting the earth surface plant status. The bio-mass detecting means includes a rotary scan mirror for detecting a reflected light component from the earth surface by scanning an earth region in a predetermined detection angle range, and a detector disposed on the emission side of the rotary scan mirror. The bio-mass detecting means includes a height gauge for obtaining the value of the plant on the earth surface by detecting the height data of the plant. The bio-mass detecting means includes a converging optical system disposed on an optical path of the rotary scan mirror and the detector.

The converting optical system is constituted by a reflective optical system. The converging optical system is constituted by a refractive optical system. The converging optical system is constituted by a reflective refractive optical system. The detector is constituted by a plurality of detectors having respective spectral bands. Spectral filters having respective spectral bands are each disposed ahead of a light incidence part of each of the detectors.

Other objects and features will be clarified from the following description with reference to attached drawings.

### BRIEF DESCRIPTION OF THE DRAWINGS

FIG. 1 is a view showing an arrangement for schematically describing an embodiment of the terrestrial environment observation satellite according to the present invention;

FIG. 2 is a characteristic graph showing an example of daily longitude changes of the terrestrial environment observation satellite shown in FIG. 1;

FIG. 3 is a block diagram showing the arrangement of a data detecting part of the terrestrial environment observation satellite shown in FIG. 1;

FIG. 4 is a schematic view showing a sensor optical part shown in FIG. 3; and

FIG. 5 is a characteristic graph showing examples of spectral sunlight reflection characteristics of plants on the earth surface.

### PREFERRED EMBODIMENTS OF THE INVENTION

Preferred embodiments of the present invention will now be described with reference to the drawings.

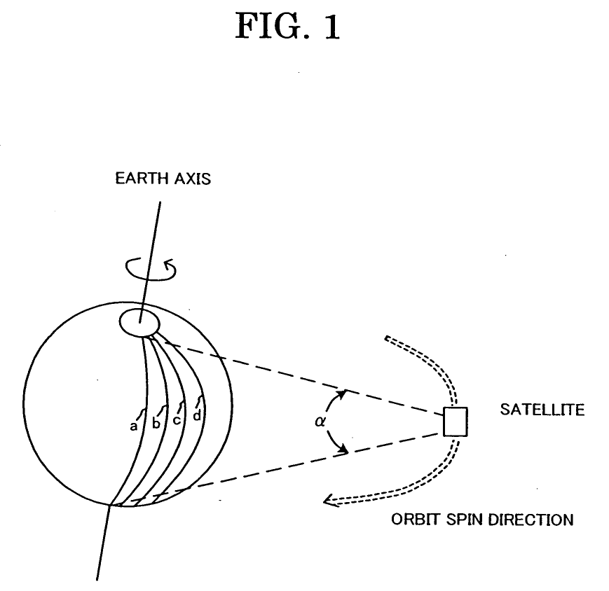

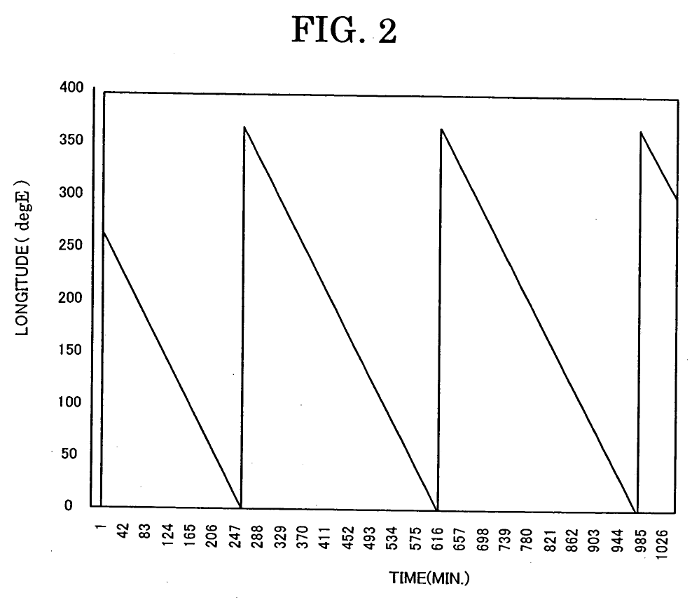

FIG. 1 is a view schematically showing the subject matter of the embodiment of the present invention. A satellite is located above the equator of the earth, which is spinning about its axis, is arranged to undergo execution along the equator in the direction opposite to the earth spin direction such as to return to a position above point on the earth a plurality of times a day. Thus, when the satellite is at a height of about 14,000 km, it scans a strip-like scan area a a plurality of times a way, for instance four times a way, as in the elapsed time versus longitude characteristic curve shown in FIG. 2. Thus, it is possible to collect bio-mass data more reliably, and the whole earth region data can be generated and recorded over a south-north angle by integration processing intermittently obtainable reflected light component from the earth surface and then progressively shifting to the following scan areas b, c, d, . . .

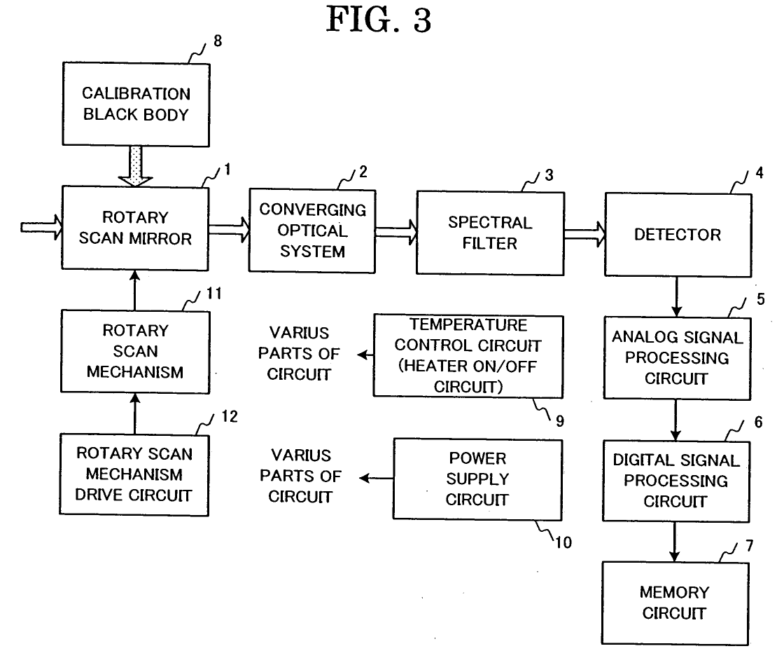

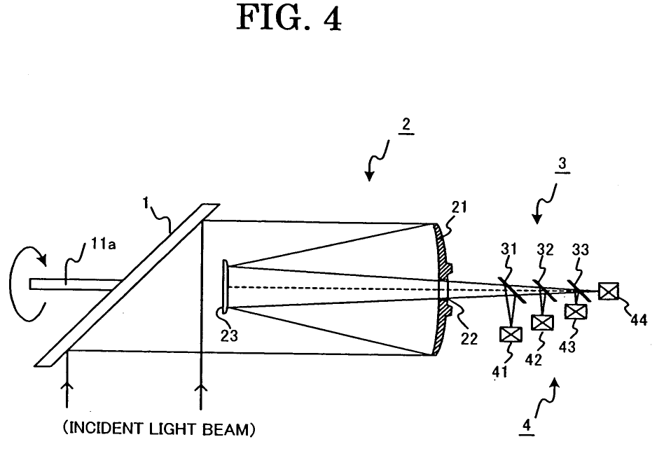

FIG. 3 is a block diagram showing the specific arrangement of the embodiment. The essential part of the embodiment is an optical path constituted by a rotary scan mirror 1, a converging optical system 2, a spectral filter 3 and a detector 4. The mechanism of the essential part is shown in FIG. 4.

Referring to FIGS. 3 and 4, the rotary scan mirror 1 is coupled to a rotary drive shaft 11a in a rotary scan mechanism 11, which is properly controlled for driving by a rotary scan mechanism drive circuit 12. The rotary drive mechanism 11a is secured at an inclination angle of 45 degrees to the center of the back surface of the plan mirror, and with the rotation of the rotary drive shaft 11a the earth can be scanned in the south-north directions to take in the reflected light component from the earth of the incident light beam.

As for the scan angle range α (in FIG. 1) of the earth in the south-north directions thereof scanned by the rotary scan mirror 1, in the case of a satellite height of 14,000 km, the scan angle range viewed from the satellite is about 20 degrees, and bio-mass data in this range on the earth can be collected.

The detection angle range on the earth in the east-west directions thereof in the scan angle range α is set such that adjacent ones of the scan regions a, d, . . . shown in FIG. 1 slight overlap each other, and a rearranging process is executed such that the result is identical with an earth map in an integration process executed after the detection.

On the emission side of the rotary scan mirror 1, the converging optical system 2, the spectral filter 3 and the detector 4 are disposed in the mentioned order. The converging optical system 2 is constituted by a first mirror 21 which is a convex mirror, and a second mirror 23 disposed as a turn-back mirror ahead of the first mirror 21. The mirror 21 has a central opening, through which a turned-back light beam from the second mirror 23 passes.

The spectral filter 3 is disposed on the optical axis of the emission side of the converging optical system 2(i.e., behind the first mirror 21). The spectral filter 3 has a first to a third filter 31 to 33 disposed in the mentioned order and each having a plurality of reflection bands, and a first to a third detector 41 to 43 are disposed at the reflection points of the filters 31 to 33, respectively. A fourth detector 44 is disposed behind the third spectral filter 33.

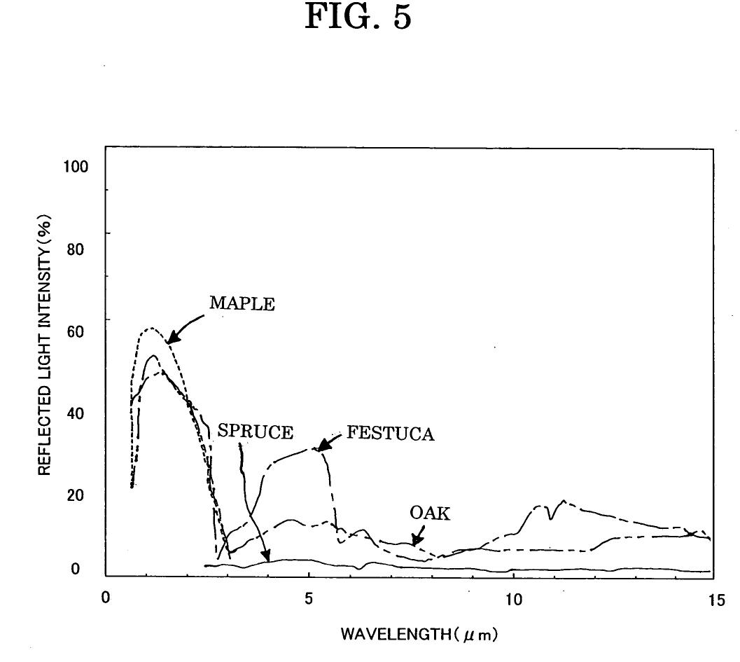

The first to fourth detectors 41 to 44 are constituted by CCD type photoelectric transducers, HgCdTe type photoelectric transducers etc., and are used in combination with the first to third spectral filters 31 to 33. The bands are set on the basis of the plant growth status such as to correspond to, for instance, spectral solar light reflection characteristics corresponding to the plant growth on the earth surface as shown in FIG. 5.

In the graph shown in FIG. 5, the abscissa is taken or the wavelength (in μm), and the ordinate represents the reflected light intensity (in %). The broken characteristic curve is of maple, the single-dot phantom characteristic curve is of festuca, the double-dot phantom characteristic curve is of oak, and the solid characteristic curve is of spruce. The reflection bands of the spectral filter 3 are set such as to conform to such featuring absorption band characteristics in the visible and infrared wavelength ranges.

The first spectral filter 31 is constituted by a half-mirror having a first reflection characteristic band, and a light flux component reflected by the first spectral filter 31 is detected by the first detector 41. The second filter 32 is constituted by a half-mirror having a reflection ban din a range different from the first reflection characteristic band, and a light beam component reflected by the second spectral filter 32 is detected by the second filter 42. Likewise, the third spectral filter 33 is constituted by a half-mirror having a reflection band in a range different from both the first and second reflection characteristic bands, and a light beam component reflected by the third spectral filter 33 is detected by the third detector 43.

The fourth detector 44 is arranged to receive an optical signal in a range not including the reflection characteristic bands of the first to third spectral filters 31 to 33.

The converging optical system 2 is constituted by a reflecting optical system. However, it is also possible to form the converging optical system with a refractive optical system formed with an optical lens or with reflective refractive optical system obtained by combining a reflective optical system and a refractive optical system, for instance by inserting a lens in the optical path of the first and second mirror 21 and 23 to reduce the length of the converging optical system 2.

The analog signal processing circuit 5 connected to the detector 4, which extracts the featuring wavelength of the received light beam and executes band division, is arranged to amplify and A/D convert the electric signal obtained by photo-electric conversion in the detector 4, and output the resultant signal to the next stage digital signal processing circuit 6. The digital signal processing circuit 6 receiving the digital signal, executes operation on the digital signal to obtain data about weather any plant is present, identification of kinds, active degree, etc., the obtained data being recorded in the recording circuit 7.

Since the satellite passes by the same point in space four times a day as it undergoes circulation around the earth, the above signal process is carried out together with an integrating process and a rearranging process of rearranging intermittent bio-mass data on a earth map during the necessary plant observation time.

The temperature control circuit 9 detects the temperatures of various parts of the sensor, and the power supply circuit 10 supplies power to various parts of the circuit. The calibration black body 8 is constituted by a halogen lamp, black body, etc., and serves as a reference light source for calibration in the detector 4.

Since terrestrial environment observation satellite located at a position above the equator of the earth which is spinning about the earth axis, is set to undergo execution along an equator orbit in the direction opposite to the earth spin direction, it undergoes execution past the same terrestrial point a plurality of times per day, and with this circulation the rotary scan mirror 1 driven for rotation, whereby the detection of a strip-like Part Of earth having a predetermined detection range in the east-west direction is made in the south-north directions of the earth. In the case of a satellite height of about 14,000 km, the strip-like part is scanned four times a day, that is, the reflected light component from the earth is incident on the rotary scan mirror 1 four times a day. The detector 4 (i.e., first to fourth detectors 41 to 44) detects the reflected light component (in the infrared and visible light bands) from the earth, and its output is amplified and A/D converted in the analog signal processing circuit 5. The next stage digital signal processing circuit 6 obtains data of whether any plant is present, identification of kinds, active degree, etc., also executes a rearranging process of rearranging intermittent data on a earth map, and records the obtained data in the recording circuit 6. The output of the recording circuit 7 is transmitted at appropriate timings to a data receiving station built on the earth, and in this way data of the whole earth regions is obtainable.

The optical sensor can Not make observation in a cloudy atmosphere. In the case of the satellite MOS (MOMO) currently in duty service, a point can be observed only twice a monthly, and disability of observation is highly possible. In contrast, this embodiment of the terrestrial environment observation satellite can make observation 120 times a month, and it is possible to substantially solve the problem of the probability that clouds bring about the disability of observation.

The above embodiment Of the terrestrial environment observation satellite according to the present invention is by no means limitative, and various changes and modifications can of course be made without departing from the scope of the invention.

For example, in this embodiment the rearranging process of rearranging intermittent data on an earth map is executed in the digital signal processing circuit 6, it is also possible to let the process be executed in a data receiving station provided on the earth. In this case, it is possible to simplify the arrangement on the side of the terrestrial environment observation satellite and improve the reliability of the satellite itself.

The height of the terrestrial environment observation satellite undergoing excursion around the earth, is not limited to 14,000 Km, but it may be above or below this value, and the setting can be appropriately changed according to total weight of the satellite and the setting of the lifetime.

It is further possible to mount a rider or like height gauge in the terrestrial environment observation satellite for detecting plant height data and obtaining the volume of the plant.

While the embodiment has concerned with an example of detecting the visible light and infrared wavelength bands, without limitation to the visible and infrared bands it is possible to permit detection in an expanded band up to the ultraviolet band so Long as the plant is has a character of a wavelength band exhibiting a featuring spectral characteristic.

Furthermore, the same arrangement as a bio-mass sensor may be used as a so-called weather satellite for obtaining such weather images as those of clouds and permitting the weather image and bio-mass observation at a time.

The terrestrial environment observation satellite according to the present invention can do observation of a point a plurality of times a day. Thus, even the bio-mass observation could not be obtained in the morning due to a great deal of clouds, if it becomes fine in the afternoon, regular observation can be made. Thus, the probability of occurrence of the status that it is impossible to make observation due to clouds is extremely reduced, the status observation in the whole earth scale can be made reliably. Also, since the integration process is executed on the side of the observation satellite, it is possible to solve the prior art problem based on position of the receiving status and the earth and readily make highly accurate observation.

Also, since a point can be observed a plurality of times a day, denoting the number of times of integration by n, the signal-to-noise ratio is imposed by n times. Since the plant quantity change is usually gentle, about one time of observation per month is sufficient. With the prior art pseudo returning orbit, in the case of, for instance, MOS (MOMO), since the cycle is 17 days, the signal-to-noise ratio is about 2 times in the integration for one month. In the case of the terrestrial environment observation satellite according to the present invention, since the cycle if 6 hours, the signal-to-noise ratio is about 120 times, and thus can be greatly improved.

Thus, it is possible to provide a terrestrial environment observation satellite, which can contribute to the solution of environmental problems posed on the whole earth scale, such as earth temperature increase, ozone layer destruction and occurrence of abnormal weather.

The terrestrial environment observation satellite according to the present invention can detect the characteristic of light reflected from the plant or the like oh the earth by using a sensor, and by analyzing the detected data it is possible to obtain terrestrial environment data such as kind of plant, growing status and active degree.

Moreover, it is possible to estimate carbon dioxide gas absorption quantity according to data obtained from the sensor, for instance plant growth quantity data and solve such environmental problems as earth temperature increase, ozone layer destruction and abnormal weather occurring on the whole earth scale.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A terrestrial environment observation satellite with a sensor mounted for detecting light reflected from the earth while undergoing excursion around the earth, wherein:
the satellite undergoes excursion along an orbit set to an equator orbit directed in a direction opposite to the direction of the earth spin, undergoes excursion to return to a terrestrial point a plurality of times a day, and executes a process of integrating intermittently obtained reflected light beam from the earth surface, thereby obtaining whole earth data.

2. The terrestrial environment observation satellite according to claim 1, wherein the sensor is constituted by a bio-mass detecting means for detecting the earth surface plant status.

3. The terrestrial environment observation satellite according to claim 2, wherein the bio-mass detecting means includes a rotary scan mirror for detecting a reflected light component from the earth surface by scanning an earth region in a predetermined detection angle range, and a detector disposed on the emission side of the rotary scan mirror.

4. The terrestrial environment observation satellite according to claim 2, wherein the bio-mass detecting means includes a height gauge for obtaining the value of the plant on the earth surface by detecting the height data of the plant.

5. The terrestrial environment observation satellite according to claim 3, wherein the bio-mass detecting means includes a converging optical system disposed on an optical path of the rotary scan mirror and the detector.

6. The terrestrial environment observation satellite according to claim 5, wherein the converting optical system is constituted by a reflective optical system.

7. The terrestrial environment observation satellite according to claim 5, wherein the converging optical system is constituted by a refractive optical system.

8. The terrestrial environment observation system according to claim 5, wherein the converging optical system is constituted by a reflective refractive optical system.

9. The terrestrial environment observation satellite according to claim 3, wherein the detector is constituted by a plurality of detectors having respective spectral bands.

10. The terrestrial environment observation satellite according to claim 9, wherein spectral filters having respective spectral bands are each disposed ahead of a light incidence part of each of the detectors.
